(19) United States
(12) Patent Application Publication
(10) Pub. No.: US 2012/0049512 A1
(43) Pub. Date: Mar. 1, 2012

(54) FLARE FITTINGS WITH CIRCUMFERENTIAL SLEEVE FOR IMPROVED HIGH PRESSURE SEAL

(76) Inventor: Frank F. Hayes, JR., Fountain Valley, CA (US)

(21) Appl. No.: 12/874,142

(22) Filed: Sep. 1, 2010

(51) Int. Cl. F16L 33/00

(52) U.S. Cl. 285/256

(57) ABSTRACT

Fitting assemblies and methods for connecting a flexible plastic tubing to a fitting. The assembly includes a thin-walled flexible sleeve positioned over a flared end of the tubing and the tube-receiving portion of the fitting in an interference fit.

### BACKGROUND

Plastic tubing and fitting assemblies are used in many applications to transfer fluid, including for example pharmaceutical, chemical, semiconductor fabrication, to name a few. Fitting assemblies can be used to connect one tubing to another, or to connect tubing to a manifold or a utilization apparatus. Under high fluid pressure, the fitting assemblies may be susceptible to leakage.

### BRIEF DESCRIPTION OF THE DRAWINGS

Features and advantages of the disclosure will readily be appreciated by persons skilled in the art from the following detailed description when read in conjunction with the drawing wherein:

FIG. 1 is a cutaway view of an exemplary embodiment of a flare fitting system with a sleeve structure.

FIG. 2A is a side view of an exemplary embodiment of a sleeve structure suitable for use with the system of FIG. 1. FIG. 2B is a cross-section view taken along line 2B-2B of FIG. 2A. FIG. 2C is an enlarged detail view of the portion of the sleeve structure indicated in FIG. 2B.

FIG. 3 is a cross-section view of an exemplary embodiment of a flare fitting nut with a sleeve inserted into the nut cavity.

FIG. 4 is a cutaway view of an exemplary embodiment of a flare fitting with a flexible tubing having a flared end assembled to the flare fitting with a sleeve in place over the flared end.

FIG. 5 is a side partially cutaway view of a multiple line fitting assembly employing a sleeve for each of the multiple lines.

FIG. 6 is a side cross-sectional view of an alternate embodiment of a multiple line fitting assembly arranged to interconnect a plurality of incoming and outgoing lines.

### DETAILED DESCRIPTION

In the following detailed description and in the several figures of the drawing, like elements are identified with like reference numerals. The figures are not to scale, and relative feature sizes may be exaggerated for illustrative purposes.

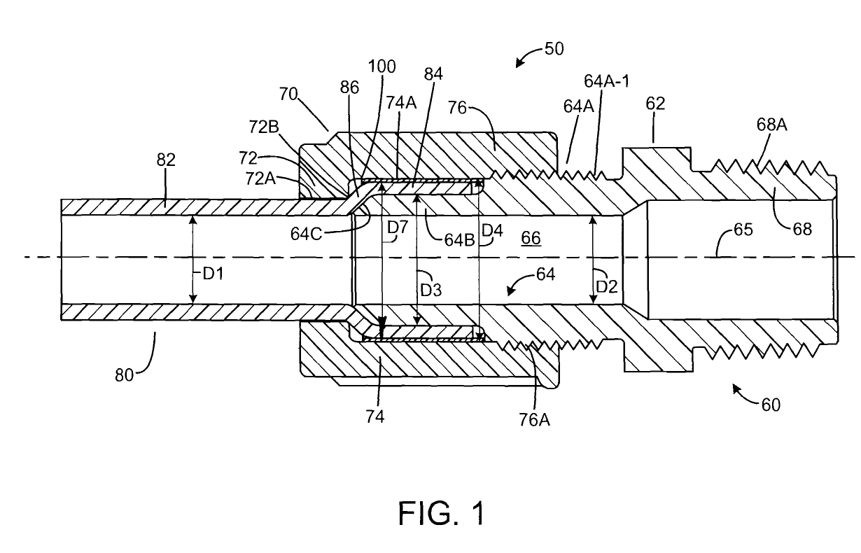

FIGS. 1-4 illustrate an exemplary embodiment of a fitting assembly 50 configured for making a connection to a plastic tubing 80. In this example, the assembly includes a hollow fitting body 60 with an intermediate flange 62, and a first fitting body portion 64 extending from the flange. The body portion 64 includes a nut receiving portion 64A having external threads 64A-1 defined thereon to engage corresponding interior threads of a nut 70. The body portion 64 further includes a hollow tubing receiving portion or nose 64B having a tapered distal end portion 64C. The tubing receiving portion may be a hollow post or nipple structure. The fitting 60 defines a hollow space 66 and has a longitudinal axis 65. The portion 64 in this embodiment has circular symmetry about the axis 65. The fitting 60 in this exemplary embodiment further includes a second fitting body portion 68 having external threads 68A defined thereon. The second fitting body portion can take various forms, depending on the particular application. In this example, the flange 62 can facilitate connection to a bulkhead, and the external threads 68A configured to connect to another fitting, pipe or tubing.

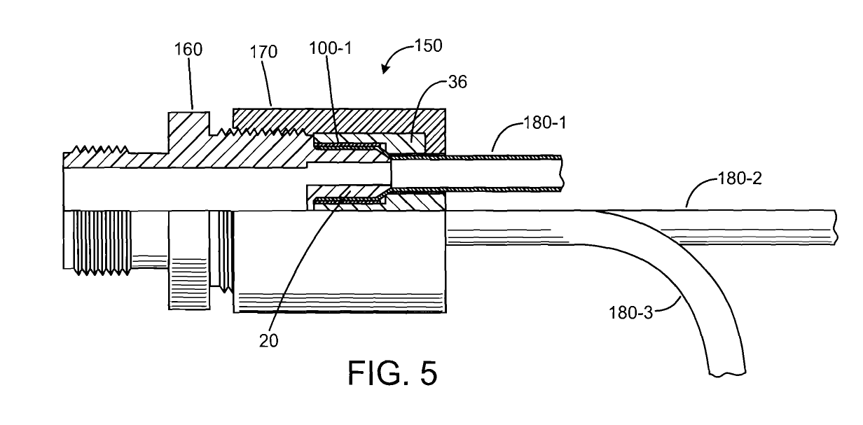

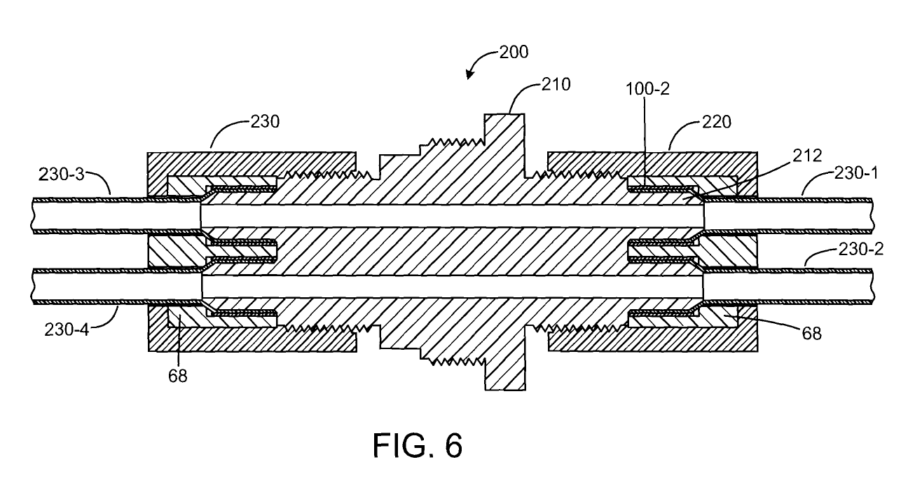

The assembly further includes a cap member 70, which in this embodiment takes the form of a threaded nut, so that the cap member or nut can be threaded onto the body member 60 to secure it in place. The nut 70 includes a closed end portion 72 having a central opening 72A defined therein, an intermediate portion 74 having a cylindrical hollow configuration an interior surface 74A defining a cavity 78, and a distal portion 76 having interior threads 76A defined therein and configured to threadingly engage the exterior threads 64A-1 on the fitting body 60. The intermediate portion 74 has a diameter D4. The cavity is configured to fit about the flared end portion of the tubing and the tubing receiving portion of the fitting body 60, with a sleeve 100 fitted about the flared end portion in an interference fit. In other embodiments in which the function provided by the cavity is separated from the securing function of a nut, the cap member need not include threads. Two such embodiments are described below with respect to FIGS. 5 and 6.

In an exemplary embodiment, the fitting 60 and cap member 70 are each fabricated of a rigid plastic material, e.g. by injection molding, such as PFA or PVDF (both high purity materials to prevent liquid contamination due to tubing or fitting contamination) Other materials can be selected, based on the demands of the particular application.

The fitting assembly further includes plastic tubing member 80 including cylindrical tubing portion 82 having a first diameter D1, which in an exemplary embodiment is nominally the same as the diameter D2 of the fitting space 66. The tubing includes a flared end portion 84 having a slightly larger diameter D3 than diameter D1, and is configured to be fitted over the tubing receiving portion 64B of the fitting 60. In an exemplary embodiment, the tubing is flexible, and fabricated from a plastic material, e.g. a fluoropolymer, for high purity applications such as pharmaceutical and semiconductor fabrication applications. For one exemplary application, the inner diameter D1 of the tubing is 0.375 inch, and the inner diameter D3 of the flared end portion is 0.375 inch. The nominal thickness of the tubing in portion 82 is 1/16 inch in this example, and may be reduced in the flared region as a result of the flaring process used to fabricate the tubing.

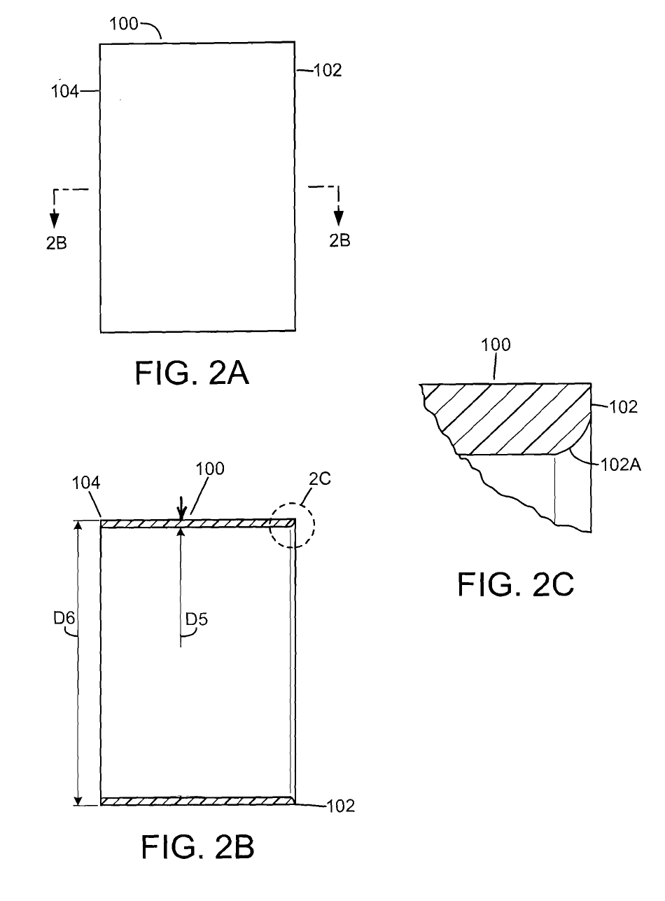

The fitting assembly 50 further includes a sleeve member 100, configured for fitting over the end portion 84 of the tubing 80 and inside the intermediate portion 74 of the nut when assembled to the fitting and tubing. The sleeve may be made of any fluoropolymer resin, such PFV, PVDF, PEEK, HALAR™ which provides a flexibility or resilience property of the sleeve. Since the sleeve does not come into contact with the liquid being carried through the tubing and fitting, in a typical application it may be fabricated from a material not deemed a high purity material. In an exemplary embodiment, the sleeve outer diameter (OD) D6 (FIG. 2B) is slightly larger than diameter D4 of the intermediate portion or cavity of the nut 70, and the sleeve inner diameter (ID) D5 is slightly smaller than the outer diameter D7 of the flared end portion of the tubing 80. Thus, there is an interference fit between the sleeve member and the flared end portion of the tubing, and preferably a slight interference fit between the sleeve and the nut, e.g. for one application on the order of one thousandth of an inch or so. In other applications, the sleeve other diameter may be the same as or slightly smaller than the nut cavity inner diameter. The sleeve is flexible, and can typically be fitted into the nut cavity even with the interference fit, since it may compress sufficiently to readily slide into the nut cavity. The interference fit improves the seal, and can also serve to maintain the sleeve in place inside the nut before the tubing is attached to the fitting.

The fitting nose portion 64B, the flared end portion 84, the sleeve 100 and the cavity wall surface 74 cooperate, with the fitting assembly in an assembled condition as shown in FIG. 1, to provide a layered circumferential seal assembly, with the sleeve accommodating tolerances of the parts from a true circular cross-sectional configuration in this example. Compressive force is applied around the circumference of the flared end 84 and along the length of portion of the sleeve contacting the flared end 84. This provides a substantially increased seal area, in contrast to the seal area provided by contact of the nut of a conventional fitting at the beveled surface 84C of the tubing. This substantially increases the seal capacity against leaks due to increased pressure.

Exemplary nominal diameter dimensions for one application are D1=0.375 inch, D2=0.375 inch, D3 (flared tubing ID)=0.545 inch, D3 (fitting nose OD)=0.55 inch, D4=0.7 inch, D5 (wall thickness of sleeve)=0.021 to 0.023 inch, D6=0.702 to 0.708 inch, and D7 (OD of flared end of tubing)=0.66 inch. For this example, the sleeve will have an interference of two to five thousandths of an inch on each side of the flared end portion 84 of the tubing 80.

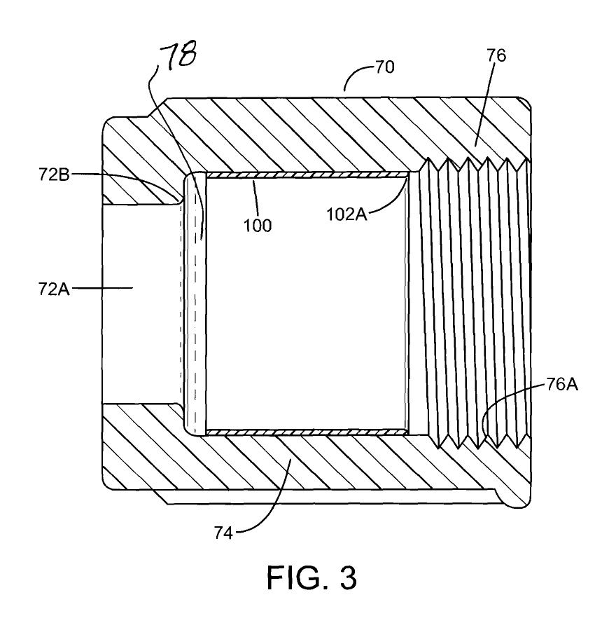

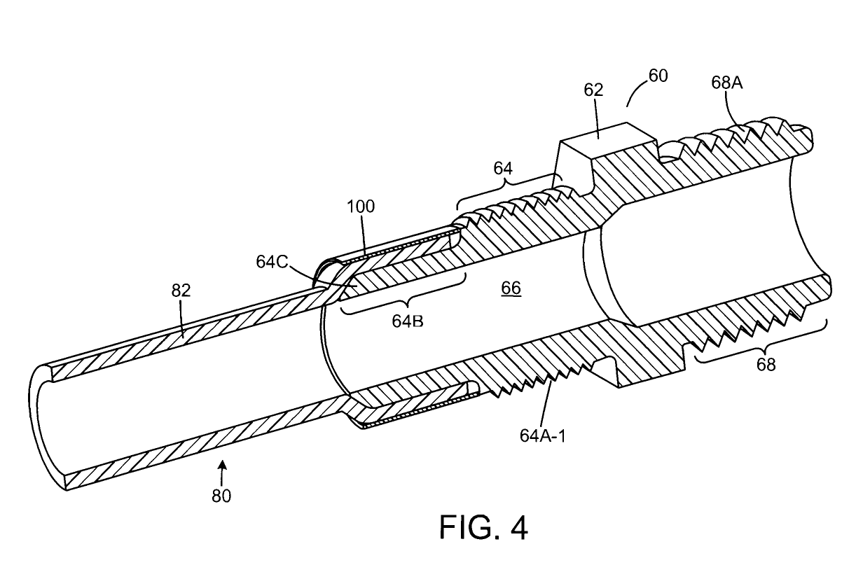

The sleeve 100 is shown in an inserted position inside the cap or nut 70 in FIG. 3. The sleeve 100 is shown in the installed position on the tubing 80, with the nut 70 not shown in FIG. 4. One preferred method of assembly of the fitting assembly 50 is to pre-position the sleeve within the nut 70 as shown in FIG. 3, then with the tubing inserted through the nut opening 72A, to insert the flare end portion of the fitting body 60 into the flared end portion of the tubing, and then to push the nut with the sleeve in the axial (65) direction to push the sleeve over the flared end portion, and continue the sliding movement until the threads of the nut come into contact with the threads 64A-1 of the fitting. The nut may be rotated to engage the threads; during the nut rotation, the sleeve may or may not rotate on the flared tubing end, and is progressively seated onto the flared end portion of the tubing until the flared end portion is covered by the sleeve. In other embodiments, the nut may have a longer length or shorter thread portion, so that the seating of the sleeve over the flared end portion of the tubing is accomplished by the sliding movement of the nut prior to thread engagement. In another method of installation, the sleeve may be slid onto the flared end of the tubing before the flared end is pushed onto the nose of the fitting, with the nut thereafter slid over the sleeve and into engagement with the fitting threads.

The sleeve member in an exemplary application provides a typical 0.003 to 0.006 inch preload on the flared portion of the tubing 80. The sleeve member as part of the fitting assembly contributes to improved leakage protection for high pressure applications. In the past, a typical leak failure may occur in a flare fitting with the nut compressing the tubing at the flare transition such as transition 86 between the flare 64C and the nut edge 74B. In the absence of a sleeve member 100, the sealing against leakage can be provided primarily by the compression at the flare transition 86, and can fail at high fluid pressures, leading to fitting leaks. However, with the sleeve 100 in place in the fitting assembly, the fluid seal is circumferential around the flared portion of the tubing surrounded by the sleeve. The nut edge 74B need not even contact or be drawn into compression against the flare transition region 86 of the tubing. This provides an increase in the fluid seal area, and thus increases the margin against leakage at higher fluid pressures. Many typical applications employ working pressures of less than 90 to 120 psi, and to provide adequate margin against pressure surges a maximum design pressure may be on the order of 2.2 times the maximum working pressure.

An exemplary embodiment of the sleeve 100 is illustrated in FIGS. 2A-2C. This embodiment of the sleeve is fabricated from a plastic material, such as PVDF, although other materials such as PFA and PEK may be used, depending on the application. The sleeve is generally cylindrical, and is relatively thin-walled in this example. To facilitate assembly of the sleeve over the flared end of a tubing, the tubing facing end 102 of the sleeve has an interior radius portion 102A, rather than a sharp corner. The opposite end 104 of the sleeve may be formed with an external chamfer, to facilitate entry of the sleeve into the intermediate portion 74 of the nut.

In another exemplary embodiment, for a 5/8 OD ( 1/2 ID) tubing size, the sleeve may have a length of 0.54 inch, an inner diameter of 0.775 inch and an outer diameter of 0.815 inch, thus providing a sleeve wall thickness of 0.040 inch. In this example, the radius portion 102A has a radius of 0.010 inch.

It is preferable that the flared end portion 84 of the tubing 80 have a uniform thickness and inner diameter, to facilitate positioning of the sleeve 100 over the flared end portion. Some flare fabrication techniques have in the past provided flexible tubing with uneven flare wall thicknesses, so that the wall thickness on one side of the flare may be thinner than the wall thickness on the opposite side of the flare. U.S. Pat. No. 7,604,472 describes a system and method for fabricating flared ends of flexible tubing which provides excellent uniformity in the dimensions of the flared ends. In a preferred embodiment, the flared end portion 84 of the tubing 80 has been fabricated by a method and apparatus as described in U.S. Pat. No. 7,604,472, the entire contents of which are incorporated herein by this reference. Preferably the wall thickness of the flared end of the tubing being covered by the sleeve will have a tolerance of within plus or minus two thousandths of an inch, readily achievable by the fabrication techniques described in U.S. Pat. No. 7,604,472.

An exemplary embodiment of the sleeve member 100 is fabricated by injection molding, e.g. using standard thin wall injection molding procedures. Such procedures may include the use of multiple gates, sub gates, tunnel gates or hot gates to achieve the provide flow of the material into the mold.

The fitting system may be configured for connection to tubing of various sizes, for example, tubing ODs of 1/4 ( 5/32 ID), 3/8 OD (0.25 inch ID), 1/2 OD ( 3/8 ID), 5/8 OD (0.5 ID), 3/4 OD ( 5/8 ID), 1 OD ( 7/8 ID), 1 1/4 OD (1.10 ID), all dimensions in inches.

While the fitting assembly 50 provides for connection of a single tubing to the fitting, in other embodiments, multiple tubes may be accommodated. For example, FIG. 5 depicts a fitting assembly 150 with three tubes 180-1, 180-2 and 180-3 connected to the fitting assembly. The fitting assembly 150 is similar to that disclosed in FIGS. 1-8 of U.S. Pat. No. 5,833,278, the entire contents of which are incorporated herein by this reference, except that a sleeve member is employed to increase the margin against fluid leakage at high pressures, as in the embodiment shown in FIGS. 1-4 herein. Thus, the assembly 150 includes a fitting body 160 (corresponding to body 14 of the '278 patent) having three hollow posts 20 protruding there from for connection to the flared end portions of a respective tubing 180-1. A compression disc member 36 as in the '278 patent serves as the cap member and is positioned over the posts and flared end portions of the tubing, and as well over the sleeve 100-1. The nut 170 secures the compression disc and tubes 180-1, 180-2 and 180-3 to the fitting body 160. In this embodiment, the sleeve is configured to fit within a corresponding bore or opening in the disc 36 in a slight interference fit, and has an interference fit relative to the flared end portion of the tubing 180-1 which is inserted into the sleeve.

FIG. 6 depicts a fitting assembly 200 for interconnecting two pairs of tubes together, and is similar to the assembly shown in FIG. 9 of the '278 patent. However, a sleeve 100-2 is fitted between the respective openings of each compression disc 68 and the flared ends of the respective tubes 230-1 . . . 230-4 mounted on the nipples 212 on the fitting body 210. The sleeves have interference fits relative to the flared end portions of the tubes, as described above with respect to the embodiments of FIGS. 1-5, and slight interference fits relative to the openings formed in the disc 68 which accept the sleeves. The sleeves provide added margin against leakage in relatively high fluid pressure applications.

Although the foregoing has been a description and illustration of specific embodiments of the subject matter, various modifications and changes thereto can be made by persons skilled in the art without departing from the scope and spirit of the invention.

What is claimed is:

1. A fitting assembly configured for making a connection to a flexible plastic tubing having a flared end portion of increased inner diameter relative to the nominal tubing diameter, the assembly comprising:
a hollow fitting body including a tubing receiving portion configured to receive the flared end portion with the flared end portion of the tubing positioned over the tubing receiving portion;
a cap member having an opening formed therein for passing therethrough the plastic tubing, the opening in communication with an interior cavity of the cap member defined by a cavity wall;
a flexible thin-wall plastic sleeve member having an inner diameter smaller than an outer diameter of the flared end portion of the plastic tubing, and an outer diameter sized to provide a sliding fit of the sleeve member into the cavity of the cap member;
wherein in an assembled condition, the tubing receiving portion, the flared end portion, the sleeve and the cavity wall formed a layered sealing arrangement compressing the flared end portion of the tubing against the tubing receiving portion of the fitting body.

2. The assembly of claim 1, wherein the cap member is defined by a nut having interior threads, and the fitting body member includes a region having external threads arranged to engage the interior threads of the nut.

3. The assembly of claim 1, wherein the fitting body member and the cap member are each fabricated of a rigid plastic material.

4. The assembly of claim 1, wherein the sleeve member is a unitary injection molded member fabricated of a fluoropolymer material.

5. The assembly of claim 1, wherein the sleeve has a longitudinal extent along a longitudinal axis of the fitting body which is at least equal in length to a longitudinal extent of the flared end portion of the tubing.

6. The assembly of claim 1, wherein the outer diameter of the sleeve is larger than the inner diameter of the cavity so as to provide an interference fit between the sleeve and the cap member.

7. The assembly of claim 1, wherein the fitting body is fabricated PFA or PVDF.

8. The assembly of claim 1, wherein the sleeve has a hollow cylindrical configuration.

9. The assembly of claim 1, wherein the sleeve has an inside radius edge at one end of the sleeve to facilitate assembly of the sleeve and the flared end of the tubing.

10. The assembly of claim 1, wherein the cap member is a disc member configured to be secured to the fitting body by a separate nut member.

11. The assembly of claim 1, wherein the fitting is configured to connect to a plurality of flexible tubings, each with a flared end portion, and the fitting body includes plurality of tubing receiving portions, and further including a plurality of the sleeve members one for each of the plurality of flexible tubings, and wherein the cap member is a disc member configured to be secured to the fitting body by a separate nut member and having a plurality of cavities each to receive the flared end portion of one of the tubings and one of the sleeve members.

12. A method for attaching a flared end of a flexible plastic tubing to a fitting body and providing a fluid seal between the flared end and the fitting body, comprising a sequence of the following steps:
positioning the flared end inside a thin-walled flexible sleeve member having an inner diameter dimension smaller than an outer diameter dimension of the flared end in an interference fit;
positioning the flared end over a tubing receiving portion of a hollow fitting body;
positioning the sleeve member within a cavity of a cap member;
wherein the tubing receiving portion, the flared end portion, the sleeve and a cavity wall formed a layered sealing arrangement compressing the flared end portion of the tubing against the tubing receiving portion of the fitting body.

13. The method of claim 12, wherein the step of positioning the sleeve member within the cavity of the cap member occurs prior to positioning the flared end inside the sleeve member.

14. The method of claim 13, wherein the step of positioning the flared end over the tubing receiving portion occurs prior to the step of positioning the flared end inside the sleeve member.

15. The method of claim 12, wherein the step of positioning the flared end inside the sleeve member occurs prior to the step of positioning the flared end over the tubing receiving portion.

16. The method of claim 12, wherein the cap member is a threaded nut member, and further including:
engaging threads of the nut with threads of the fitting body to secure the nut and the flared end with the sleeve to the fitting body.
